(19) United States
(12) Patent Application Publication
(10) Pub. No.: US 2018/0046322 A1
(43) Pub. Date: Feb. 15, 2018

(54) DRIVING METHOD FOR TOUCH DISPLAY DEVICE AND DRIVING SYSTEM OF THE SAME

(71) Applicant: Wuhan China Star Optoelectronics Technology Co., Ltd., Wuhan (CN)

(72) Inventors: Man LI, Shenzhen (CN); Feilin JI, Shenzhen (CN); Chun-hung HUANG, Shenzhen (CN)

(73) Assignee: Wuhan China Star Optoelectronics Technology Co., Ltd., Wuhan (CN)

(21) Appl. No.: 15/294,475

(22) Filed: Oct. 14, 2016

(30) Foreign Application Priority Data
Aug. 12, 2016 (CN) 201610661539.0

(51) Int. Cl. G06F 3/041; G06F 3/044

(52) U.S. Cl. CPC G06F 3/0418; G06F 3/0412; G06F 3/044; G06F 2203/04102

(57) ABSTRACT

A driving method for a touch display device includes receiving a wake up signal and a display start signal; downloading an initialization code and a touch-control configuration code in order to finish a display initialization and touch operation initialization; and receiving display data and generating touch data being processed to finish a normal display and touch operation. A driving system is also disclosed, including a touch panel and an integrated driving chip used for driving the touch panel to perform a normal display and touch operation, wherein, the integrated driving chip for touching and displaying is configured to receive a wake up signal and a display start signal; download an initialization code and a touch-control configuration code in order to finish a display initialization and touch operation initialization; and receive display data and generating touch data being processed in order to finish the normal display and touch operation.

### BACKGROUND OF THE INVENTION

### 1. Field of the Invention

The present invention relates to a display technology field, and more particularly to a driving method and a driving system for a touch display device.

### 2. Description of Related Art

Currently, a capacitive touch screen usually adopts three technologies of OGS (One Glass Solution, that is, an integrated touch control), On-Cell (add-on type) and In-Cell (embedded type). Wherein, a capacitive touch screen using the In-Cell technology has advantages in the manufacturing process. Comparing to a capacitive touch screen using the OGS technology or the On-Cell technology, the In-Cell technology has advantages of thinner, better light transmission, more stable in structure.

In the capacitive touch screen using the In-Cell technology, usually, a liquid crystal panel or an OLED (Organic Light-Emitting Diode) display panel are adopted as a display screen. At the same time, a driving system is adopted to drive the liquid crystal panel or the OLED panel. However, the current driving system make communication operations between the liquid crystal panel or the OLED display panel and an external main board to be frequent and complex such that an configuration process of initial parameters is time-consuming and laborious.

### SUMMARY OF THE INVENTION

In order to solve the above technology problem, the present invention provides a driving method and a driving system for a touch display device which can make communication operations between the touch panel and an external main board to be more flexible and simple, and the configuration process of initial parameters to be time-saving and effortless.

According to one aspect of the present invention, a driving method for a touch display device is provided, comprising: receiving a wake up signal and a display start signal; downloading an initialization code and a touch-control configuration code in order to finish a display initialization and touch operation initialization; and receiving display data and generating touch data being processed in order to finish a normal display and touch operation.

Furthermore, after the touch display device has an abnormal power outage, repowering the touch display device and using the driving method to drive the touch display device again.

Furthermore, receiving the wake up signal and the display start signal by adopting an integrated driving chip for touching and displaying of the touch display device through a flexible printed circuit board packaged with circuit from an external main board.

Furthermore, downloading the initialization code and the touch-control configuration code by utilizing the integrated driving chip for touching and displaying from a flash memory of the flexible printed circuit board in order to finish a display initialization and a touch operation initialization.

Furthermore, receiving display data by utilizing the integrated driving chip for touching and displaying through the flexible printed circuit board from the external main board, and transmitting the touch data generated and processed by the integrated driving chip for touching and displaying through the flexible printed circuit board to the external main board in order to finish the normal display and touch operation.

According to another aspect of the present invention, a driving system for a touch display device is provided, comprising: a touch panel and an integrated driving chip for touching and displaying used for driving the touch panel to perform a normal display and touch operation, wherein, the integrated driving chip for touching and displaying is configured to receive a wake up signal and a display start signal; download an initialization code and a touch-control configuration code in order to finish a display initialization and touch operation initialization; and receive display data and generating touch data being processed in order to finish the normal display and touch operation.

Furthermore, after the touch display device has an abnormal power outage, repowering the touch display device and the integrated driving chip for touching and displaying is re-configured to receive a wake up signal and a display start signal; download an initialization code and a touch-control configuration code in order to finish a display initialization and touch operation initialization; and receive display data and generating touch data being processed in order to finish the normal display and touch operation.

Furthermore, the integrated driving chip for touching and displaying is connected to an external main board through a flexible printed circuit board packaged with circuit, and the integrated driving chip is further configured to receive the wake up signal and the display start signal through the flexible printed circuit board packaged with circuit from the external main board.

Furthermore, the flexible printed circuit board comprises a flash memory, and the integrated driving chip for touching and displaying is further configured to downloading the initialization code and the touch-control configuration code from the flash memory in order to finish a display initialization and a touch operation initialization.

Furthermore, the integrated driving chip for touching and displaying is further configured to receive the display data from the external main board through the flexible printed circuit board and to transmit the touch data generated and processed by the integrated driving chip through the flexible printed circuit board to the external main board in order to finish the normal display and touch operation.

The technology solution of the present invention make the configuration process of the integrated driving chip for touching and displaying to be more flexible and simple in order to make the communication operations between the external main board and the integrated driving chip for touching and displaying to be more flexible and simple.

### BRIEF DESCRIPTION OF THE DRAWINGS

Through following to combine figures to describe in detail, the above, the other purposes, the features and benefits of the exemplary embodiment of the present disclosure will become clearer, wherein:

FIG. 1 is a schematic diagram of a touch display device according to an embodiment of the present invention; and

FIG. 2 is a flow chart of a driving method for a touch display device according to an embodiment of the present invention.

### DETAILED DESCRIPTION OF THE PREFERRED EMBODIMENT

The following content combines with the drawings and the embodiments for describing the present invention in detail. However, many other forms can be used to implement the present invention. Besides, the present invention should not be interpreted to be limit in the specific embodiment described here. On the contrary, the embodiments provided here are used for explaining the operation principle and practical application such that person skilled in the art can under various embodiments of the present invention and various modification suitable for specific applications.

It should be noted that in the present embodiment, a capacitive touch screen using In-Cell technology is adopted as an example for illustrating. The capacitive touch screen using In-Cell technology can be a liquid crystal panel or an organic light-emitting diode display panel.

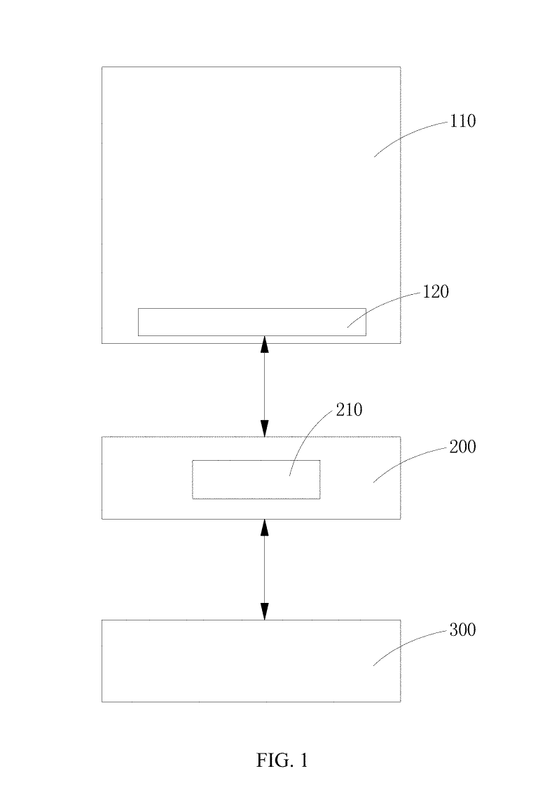

FIG. 1 is a schematic diagram of a touch display device according to an embodiment of the present invention.

With reference to FIG. 1, the touch display device according to an embodiment of the present invention includes a capacitive touch screen (that is, a touch panel) 110 adopting In-Cell technology and an integrated driving chip (touch display driver IC) 120 for touching and displaying to drive the capacitive touch screen 110 adopting In-Cell technology in order to perform a normal display and touch operation.

In the present embodiment, the integrated driving chip 120 for touching and displaying is connected to a flexible circuit board (that is, FPCA) 200 packaged with circuit. Besides, the FPCA 200 is also connected to an external main board 300. Here, the external main board 300 means a controlling main board in an electric device adopting the touch display device of the present embodiment such as a main board in a smart phone.

Preferably, in the present embodiment, the integrated driving chip 120 for touching and displaying is configured to receive a wake up signal and a display start signal from the external main board 300. Here, after the integrated driving chip 120 for touching and displaying has received the wake up signal and the display start signal, preparing for starting to operate is finished.

Optionally, the integrated driving chip 120 for touching and displaying is further configured to download an initialization code and a touch-control configuration code from a flash memory (Flash) 210 of the FPCA 200 in order to finish a display initialization and a touch operation initialization. In the present embodiment, preferably, the FPCA 200 is provided with the flash memory 210. Wherein, the initialization code and the touch-control configuration code are both stored in the flash memory 210 of the FPCA 200. By this way, the integrated driving chip 120 for touching and displaying directly download the initialization code and the touch-control configuration code from the flash memory 210 of the FPCA 200 such that the configuration process of the integrated driving chip 120 for touching and displaying is more flexible and simple.

It should be noted that in another embodiment, the flash memory (Flash) 210 of the FPCA 200 can be replaced by a phase change memory (PRAM), a static random access memory (SRAM), a dynamic random access memory (DRAM), other types of random access memory (RAM), a read-only memory (ROM) or electrically erasable programmable read only memory (EEPROM).

Optionally, the integrated driving chip 120 for touching and displaying is further configured to receive display data from the external main board 300 through FPCA 200, and configured to transmit touch data being processed and generated by the integrated driving chip 120 for touching and displaying to the external main board 300 through the FPCA 200 in order to finish a normal display and touch operation of the driving touch panel 110.

Besides, it should be noted that after the touch display device according to the embodiment of the present invention has an abnormal power outage, repowering the touch display device, the integrated driving chip (Touch display driver IC) 120 for touching and displaying of the touch display device after being repowered is re-configured according to the above configuration in order to finish the driving for the touch panel 110 again.

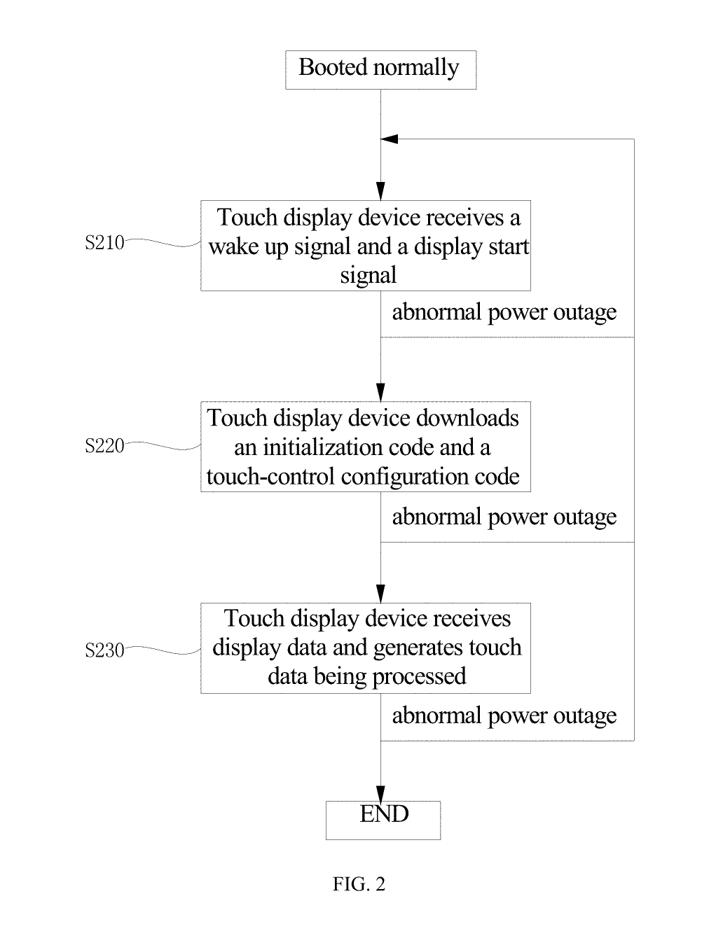

FIG. 2 is a flow chart of a driving method for a touch display device according to an embodiment of the present invention.

With reference to FIG. 1 and FIG. 2, in a step S210, after the touch display device is booted normally, the touch display device receives a wake up signal and a display start signal.

Specifically, the integrated driving chip (Touch display driver IC) 120 for touching and displaying receives the wake up signal and the display start signal from the external main board 300. Here, after the integrated driving chip 120 for touching and displaying has received the wake up signal and the display start signal, preparing for starting to operate is finished.

In a step S220, the touch display device downloads an initialization code and a touch-control configuration code in order to finish a display initialization and a touch operation initialization.

Specifically, the integrated driving chip 120 for touching and displaying downloads the initialization code and the touch-control configuration code from a flash memory (Flash) 210 of the FPCA 200 in order to finish the display initialization and the touch operation initialization. The integrated driving chip 120 for touching and displaying directly downloads the initialization code and the touch-control configuration code from the flash memory 210 of the FPCA 200 such that the configuration process of the integrated driving chip 120 for touching and displaying is more flexible and simple.

In a step S230, the touch display device receives display data and generates touch data being processed in order to finish a normal display and touch operation.

Specifically, the integrated driving chip 120 for touching and displaying receives the display data from the external main board 300 through FPCA 200, and transmits the touch data being processed and generated by the integrated driving chip 120 for touching and displaying to the external main board 300 through the FPCA 200 in order to finish the normal display and touch operation of the touch panel 110.

Besides, in the above touch display device and the driving method for the same, when an electrostatic discharge (ESD) phenomenon is generated in the touch display device, the external main board 300 directly re-downloads the initialization code from the flash memory of the FPCA 200, which greatly increases an antistatic ability of the integrated driving chip 120 for touching and displaying.

It should be noted that when the touch display device performs the above steps, if the touch display device has an abnormal power outage, repowering the touch display device. After the touch display device is rebooted normally, performing a normal driving for the touch display device according to the step S210 to the step S230 again.

Except making the configuration process of the integrated driving chip 120 for touching and displaying to be more flexible and simple, when an abnormal power outage is generated, the step for rebooting the system is simpler. Besides, if there is an update of the initialization codes, the flash memory of the FPCA 200 can be burned about ten thousand times such that the update of the initialization code is more convenient.

The above embodiments are only exemplary to describe the present invention. However, the person skilled in the art can understand: without exceeding the principle and spirit of the present invention, the above embodiments can perform various modifications in forms and minutiae.

What is claimed is:

1. A driving method for a touch display device, comprising:
receiving a wake up signal and a display start signal;
downloading an initialization code and a touch-control configuration code in order to finish a display initialization and touch operation initialization; and
receiving display data and generating touch data being processed in order to finish a normal display and touch operation.

2. The driving method according to claim 1, wherein, after the touch display device has an abnormal power outage, repowering the touch display device and using the driving method to drive the touch display device again.

3. The driving method according to claim 1, wherein, receiving the wake up signal and the display start signal by adopting an integrated driving chip for touching and displaying of the touch display device through a flexible printed circuit board packaged with circuit from an external main board.

4. The driving method according to claim 2, wherein, receiving the wake up signal and the display start signal by adopting an integrated driving chip for touching and displaying of the touch display device through a flexible printed circuit board packaged with circuit from an external main board.

5. The driving method according to claim 3, wherein, downloading the initialization code and the touch-control configuration code by utilizing the integrated driving chip for touching and displaying from a flash memory of the flexible printed circuit board in order to finish a display initialization and a touch operation initialization.

6. The driving method according to claim 4, wherein, downloading the initialization code and the touch-control configuration code by utilizing the integrated driving chip for touching and displaying from a flash memory of the flexible printed circuit board in order to finish a display initialization and a touch operation initialization.

7. The driving method according to claim 5, wherein, receiving display data by utilizing the integrated driving chip for touching and displaying through the flexible printed circuit board from the external main board, and transmitting the touch data generated and processed by the integrated driving chip for touching and displaying through the flexible printed circuit board to the external main board in order to finish the normal display and touch operation.

8. The driving method according to claim 6, wherein, receiving display data by utilizing the integrated driving chip for touching and displaying through the flexible printed circuit board from the external main board, and transmitting the touch data generated and processed by the integrated driving chip for touching and displaying through the flexible printed circuit board to the external main board in order to finish the normal display and touch operation.

9. A driving system for a touch display device comprising a touch panel and an integrated driving chip for touching and displaying used for driving the touch panel to perform a normal display and touch operation, wherein,
the integrated driving chip for touching and displaying is configured to receive a wake up signal and a display start signal; download an initialization code and a touch-control configuration code in order to finish a display initialization and touch operation initialization; and receive display data and generating touch data being processed in order to finish the normal display and touch operation.

10. The driving system according to claim 9, wherein, after the touch display device has an abnormal power outage, repowering the touch display device and the integrated driving chip for touching and displaying is re-configured to receive a wake up signal and a display start signal; download an initialization code and a touch-control configuration code in order to finish a display initialization and touch operation initialization; and receive display data and generating touch data being processed in order to finish the normal display and touch operation.

11. The driving system according to claim 9, wherein, the integrated driving chip for touching and displaying is connected to an external main board through a flexible printed circuit board packaged with circuit, and the integrated driving chip is further configured to receive the wake up signal and the display start signal through the flexible printed circuit board packaged with circuit from the external main board.

12. The driving system according to claim 10, wherein, the integrated driving chip for touching and displaying is connected to an external main board through a flexible printed circuit board packaged with circuit, and the integrated driving chip is further configured to receive the wake up signal and the display start signal through the flexible printed circuit board packaged with circuit from the external main board.

13. The driving system according to claim 11, wherein, the flexible printed circuit board comprises a flash memory, and the integrated driving chip for touching and displaying is further configured to downloading the initialization code and the touch-control configuration code from the flash memory in order to finish a display initialization and a touch operation initialization.

14. The driving system according to claim 12, wherein, the flexible printed circuit board comprises a flash memory, and the integrated driving chip for touching and displaying is further configured to downloading the initialization code and the touch-control configuration code from the flash memory in order to finish a display initialization and a touch operation initialization.

15. The driving system according to claim 13, wherein, the integrated driving chip for touching and displaying is further configured to receive the display data from the external main board through the flexible printed circuit board and to transmit the touch data generated and processed by the integrated driving chip through the flexible printed circuit board to the external main board in order to finish the normal display and touch operation.

16. The driving system according to claim 14, wherein, the integrated driving chip for touching and displaying is further configured to receive the display data from the external main board through the flexible printed circuit board and to transmit the touch data generated and processed by the integrated driving chip through the flexible printed circuit board to the external main board in order to finish the normal display and touch operation.
